(19) United States
(12) Patent Application Publication
(10) Pub. No.: US 2025/0201114 A1
(43) Pub. Date: Jun. 19, 2025

(54) EXTERNAL ENVIRONMENT RECOGNITION DEVICE AND EXTERNAL ENVIRONMENT RECOGNITION METHOD

(71) Applicant: Hitachi Astemo, Ltd., Hitachinaka-shi, Ibaraki (JP)

(72) Inventors: Kota IRIE, Hitachinaka-shi, Ibaraki (JP); Hirotomo SAI, Hitachinaka-shi, Ibaraki (JP); Takakiyo YASUKAWA, Hitachinaka-shi, Ibaraki (JP)

(73) Assignee: Hitachi Astemo, Ltd., Hitachinaka-shi, Ibaraki (JP)

(21) Appl. No.: 18/845,695

(22) PCT Filed: Mar. 11, 2022
(86) PCT No.: PCT/JP2022/010871

§ 371 Date: Sep. 10, 2024

(51) Int. Cl. G08G 1/015; G06V 10/12; G06V 10/75; G06V 20/56; G06V 20/58; G06V 20/64; G08G 1/04; G08G 1/16

(52) U.S. Cl. CPC G08G 1/015; G06V 10/12; G06V 10/759; G06V 20/58; G06V 20/588; G06V 20/64; G08G 1/04; G08G 1/166; G06V 2201/08

(57) ABSTRACT

Provided is an external environment recognition device capable of determining a place where a host vehicle can safely evacuate at the time of recognition of a specific vehicle by using a plurality of cameras in combination even in a vehicle not equipped with a distance sensor such as a radar, a LiDAR, an ultrasonic sensor, or an infrared sensor. Therefore, an external environment recognition device includes: a plurality of cameras installed so as to have a plurality of stereo vision regions in which at least a part of a visual field region overlaps around a host vehicle; a three-dimensional information generation unit that generates three-dimensional information by performing stereo matching processing in each of the plurality of stereo vision regions; a three-dimensional information accumulation unit that accumulates the three-dimensional information generated during traveling of the host vehicle in time series; and a three-dimensional information update unit that updates the three-dimensional information accumulated in the three-dimensional information accumulation unit using three-dimensional information newly generated by the three-dimensional information generation unit.

### TECHNICAL FIELD

The present invention relates to an external environment recognition device that recognizes an external environment of a host vehicle using a plurality of cameras in combination, and an external environment recognition method.

### BACKGROUND ART

In the automated driving system at Level 3 or higher, in a case where a vehicle that should give way (hereinafter, referred to as a “specific vehicle”), represented by an emergency vehicle such as a police vehicle or a fire vehicle, approaches the host vehicle, it is necessary to autonomously execute evacuation control such as deceleration or stopping so as not to disturb the travel of the specific vehicle. As a conventional technique for performing such autonomous evacuation control, an emergency vehicle evacuation control device disclosed in PTL 1 is known.

In the abstract of PTL 1, “Provided is an emergency vehicle evacuation control device capable of recognizing a position of an emergency vehicle with higher accuracy.” is described as an object, and “An emergency vehicle evacuation control device 32 includes an emergency vehicle recognition unit 38 that recognizes an emergency vehicle on the basis of information acquired by a first method and information acquired by a second method, an another vehicle recognition unit 40 that recognizes another vehicle around a host vehicle 10, and an evacuation control unit 44 that performs evacuation control so as to evacuate the host vehicle 10 in a case where the emergency vehicle is recognized, in which the emergency vehicle recognition unit 38 recognizes the emergency vehicle using one of the information acquired by the first method and the information acquired by the second method according to the number of other vehicles located within a range less than a predetermined distance with respect to the host vehicle 10.” is described as a solution.

Further, in the specification and the drawings of PTL 1, it is described that whether the emergency vehicle is recognized is determined using a camera (corresponding to the first method described above) or a microphone (corresponding to the second method described above) (Paragraphs 0027 to 0030 of the description, S3 to S6 of FIG. 3, and the like), and when the emergency vehicle is recognized, the travel control is interrupted and the process shifts to the evacuation control (paragraph 0035 of specification, S9 of FIG. 3, etc.).

### CITATION LIST

### Patent Literature

PTL 1: JP 2021-128399 A

### SUMMARY OF INVENTION

### Technical Problem

However, PTL 1 relates to where to evacuate the host vehicle at the time of recognizing the emergency vehicle, and describes in paragraph 0022 that “the evacuation operation is, for example, an operation of moving vehicle to an edge of a road and stopping the vehicle 10. In addition, the evacuation operation is, for example, an operation of stopping the vehicle 10 before the intersection even when a signal of a traveling lane of the vehicle 10 at the intersection is a green light (a signal for permitting entry into the intersection). However, a specific method for determining whether “an edge of a road” or “before the intersection” as a saving destination can actually be saved is not described.

On the other hand, paragraph 0012 of PTL 1 also describes “In addition to the cameras 14a to 14d, the vehicle 10 may include a radar, a LiDAR, an ultrasonic sensor, an infrared sensor, or the like that acquires information according to the distance between the vehicle 10 and an object.”, and thus it is considered that “an edge of a road” or “before an intersection” that can actually be evacuated can be specified by using a radar, a LiDAR, an ultrasonic sensor, an infrared sensor, or the like. However, in a case where a plurality of distance sensors are provided in addition to a plurality of cameras, there is a problem that the manufacturing cost as an emergency vehicle evacuation control system increases.

Therefore, an object of the present invention is to provide an external environment recognition device and an external environment recognition method capable of determining a place where the host vehicle can safely retreat at the time of recognition of a specific vehicle by using a plurality of cameras in combination even in a vehicle not equipped with a distance sensor such as a radar, a LiDAR, an ultrasonic sensor, or an infrared sensor.

### Solution to Problem

In order to solve the above problem, an external environment recognition device of the present invention is an external environment recognition device includes: a plurality of cameras installed so as to have a plurality of stereo vision regions in which at least a part of a visual field region overlaps around a host vehicle; a three-dimensional information generation unit that generates three-dimensional information by performing stereo matching processing in each of the plurality of stereo vision regions; a three-dimensional information accumulation unit that accumulates the three-dimensional information generated during traveling of the host vehicle in time series; and a three-dimensional information update unit that updates the three-dimensional information accumulated in the three-dimensional information accumulation unit using three-dimensional information newly generated by the three-dimensional information generation unit.

### Advantageous Effects of Invention

According to the external environment recognition device and the external environment recognition method of the present invention, it is possible to determine a place where the host vehicle can safely retreat at the time of recognition of a specific vehicle by using a plurality of cameras in combination even in a vehicle not equipped with a distance sensor such as a radar, a LiDAR, an ultrasonic sensor, or an infrared sensor.

### BRIEF DESCRIPTION OF DRAWINGS

FIG. 1 is a functional block diagram of an external environment recognition device according to a first embodiment.

FIG. 2 is a top view illustrating a relationship between a visual field region and a stereo vision region of each camera.

FIG. 3 is a flowchart of free space recognition processing by the external environment recognition device of the first embodiment.

FIG. 4 is a specific example of three-dimensional information update processing by the external environment recognition device of the first embodiment.

FIG. 5 is a flowchart of vehicle action plan generation processing by the external environment recognition device of the first embodiment.

FIG. 6A is an example of a situation where only the entire width of the emergency vehicle can be measured.

FIG. 6B is an example of a situation where only the entire height of the emergency vehicle can be measured.

FIG. 7 is an example of evacuation control of the host vehicle after specific vehicle recognition.

FIG. 8 is an example of evacuation control of the host vehicle after specific vehicle recognition.

FIG. 9 is an example of evacuation control of the host vehicle after specific vehicle recognition.

FIG. 10 is an example of evacuation control of the host vehicle after specific vehicle recognition.

FIG. 11 is an example of evacuation control of the host vehicle after specific vehicle recognition.

FIG. 12 is a functional block diagram of an external environment recognition device of a second embodiment.

### DESCRIPTION OF EMBODIMENTS

Hereinafter, details of an external environment recognition device and an external environment recognition method of the present invention will be described with reference to the drawings.

### First Embodiment

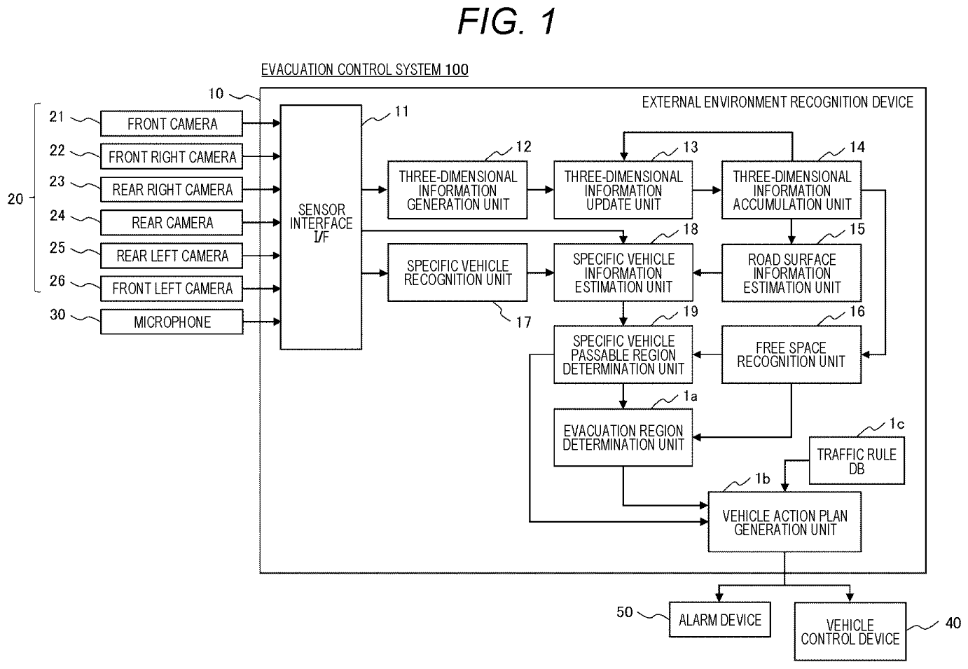

First, an external environment recognition device 10 of a first embodiment mounted on a host vehicle 1 will be described with reference to FIGS. 1 to 11.

FIG. 1 is a functional block diagram of an evacuation control system 100 including the external environment recognition device 10 of the present embodiment. As illustrated here, in the evacuation control system 100 of the present embodiment, a camera 20 (21 to 26) and a microphone 30 are connected to the input side of the external environment recognition device 10, and a vehicle control device 40 and an alarm device 50 are connected to the output side. Hereinafter, the external environment recognition device 10 will be described in detail after outlining the camera 20, the microphone 30, the vehicle control device 40, and the alarm device 50.

### <Camera 20>

The camera 20 is a sensor that captures the surrounding images of the host vehicle 1, and a plurality of cameras 20 (21 to 26) are installed in the host vehicle 1 of the present embodiment so as to be able to image the entire circumference.

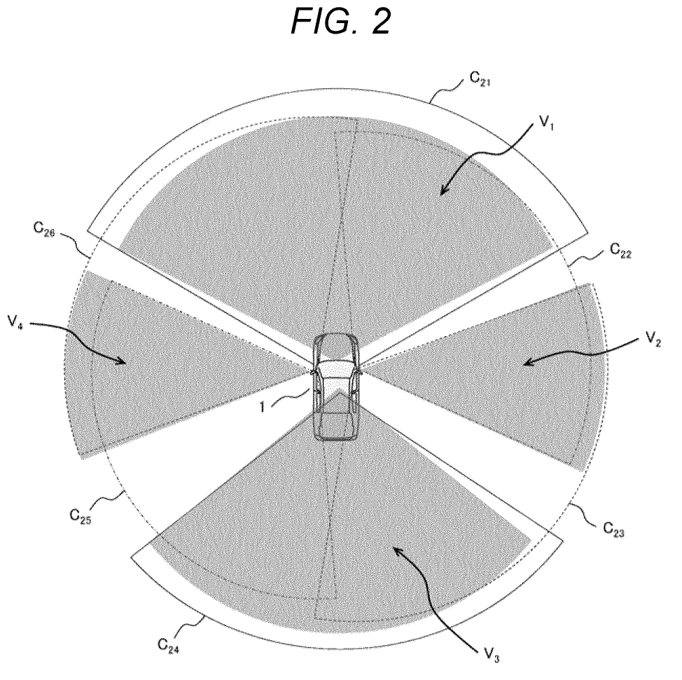

FIG. 2 is a top view of the host vehicle 1, and is a diagram illustrating a relationship between a visual field region C of each camera 20 and a stereo vision region V. As shown here, in the host vehicle 1 of the present embodiment, a front camera 21 that captures image data P₂₁ of a front visual field region C₂₁ indicated by the solid line, a front right camera 22 that captures image data P₂₂ of a front right visual field region C₂₂ indicated by the one-dot chain line, a rear right camera 23 that captures image data P₂₃ of a rear right visual field region C₂₃ indicated by the broken line, a rear camera 24 that captures image data P₂₄ of a rear visual field region C₂₄ indicated by the solid line, a rear left camera 25 that captures image data P₂₆ of a rear left visual field region C₂₅ indicated by the one-dot chain line, and a front left camera 26 that captures image data P₂₆ of a front left visual field region C₂₆ indicated by the broken line are installed. These six cameras 20 can capture the entire circumference of the host vehicle 1.

Note that, in FIG. 2, each of the visual field regions C is illustrated as if the imaging limit distances of the respective cameras are different, but this expression is intended to easily distinguish the directions of the visual field regions C of the respective cameras, and does not indicate that the imaging limit distances of the respective cameras are in the illustrated relationship.

In a region where a plurality of visual field regions C overlap, the same object can be captured from a plurality of line-of-sight directions (stereo imaging), and three-dimensional information of a captured object (surrounding moving object, stationary object, road surface, and the like) can be generated by using a known stereo matching technique. Therefore, a region where the visual field regions C overlap is hereinafter referred to as a stereo vision region V. Note that FIG. 2 illustrates a stereo vision region V₁ in the forward direction, a stereo vision region V₂ in the right direction, a stereo vision region V₃ in the backward direction, and a stereo vision region V₄ in the left direction, but the number and directions of the stereo vision regions V are not limited to this example.

### <Microphone 30>

The microphone 30 is a sensor that collects sounds around the host vehicle 1, and is used to collect a siren emitted by a specific vehicle 2 such as a police vehicle or a fire vehicle during emergency travel in the present embodiment.

### <Vehicle Control Device 40>

The vehicle control device 40 is a control device that is connected to a steering system, a driving system, and a braking system (not illustrated) and causes the host vehicle 1 to autonomously travel at a desired speed in a desired direction by controlling these systems. In the present embodiment, the vehicle control device is used when the host vehicle 1 autonomously moves toward a predetermined evacuation region at the time of recognition of the specific vehicle 2 or when the host vehicle 1 travels at a low speed in a lane avoiding the specific vehicle 2.

### <Alarm Device 50>

Specifically, the alarm device 50 is a user interface such as a display, a lamp, or a speaker, and in the present embodiment, is used to notify an occupant that the host vehicle 1 has been switched to the evacuation control mode when the specific vehicle 2 is recognized, that the host vehicle 1 has returned to the automatic driving mode after the specific vehicle 2 has passed, or the like.

### <External Environment Recognition Device 10>

The external environment recognition device 10 is a device that acquires three-dimensional information around the host vehicle 1 on the basis of the output (image data P) of the camera 20, and determines the evacuation region of the host vehicle 1 and generates a vehicle action plan toward the evacuation region in a case where the specific vehicle 2 is recognized on the basis of the output of the camera 20 or the output (audio data A) of the microphone 30.

Note that the external environment recognition device 10 is specifically a computer including an arithmetic device such as a CPU, a storage device such as a semiconductor memory, and hardware such as a communication device. Then, the arithmetic device executes a predetermined program to realize each functional unit such as a three-dimensional 1 information generation unit 12 to be described later, and hereinafter, such a well-known technique will be appropriately omitted.

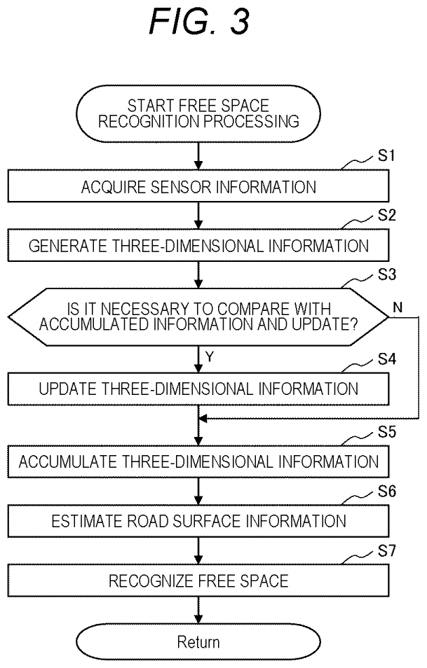

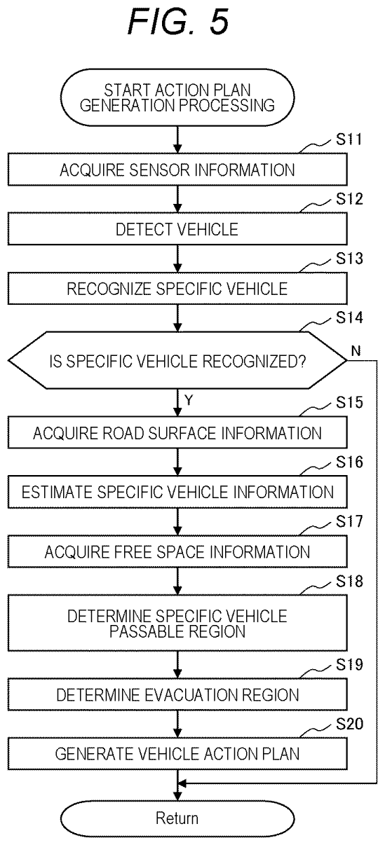

As illustrated in FIG. 1, the external environment recognition device 10 of the present embodiment includes a sensor interface 11, a three-dimensional information generation unit 12, a three-dimensional information update unit 13, a three-dimensional information accumulation unit 14, a road surface information estimation unit 15, a free space recognition unit 16, a specific vehicle recognition unit 17, a specific vehicle information estimation unit 18, a specific vehicle passable region determination unit 19, an evacuation region determination unit 1a, a vehicle action plan generation unit 1b, and a traffic rule database 1c. Hereinafter, the functions of the respective units will be sequentially described with reference to the flowcharts of FIGS. 3 and 5.

### <<Flowchart of Free Space Recognition Processing>>

First, processing for recognizing a space (free space) in which the host vehicle 1 can safely travel, which is constantly performed during automatic driving of the host vehicle 1, will be described with reference to a flowchart of FIG. 3.

In step S1, the sensor interface 11 receives the image data P (P₂₁ to P₂₆) from the camera 20 (21 to 26), and transmits the image data P to the three-dimensional information generation unit 12.

In step S2, the three-dimensional information generation unit 12 generates three-dimensional information for each unit region based on the plurality of pieces of image data P obtained by imaging the stereo vision region V, and transmits the three-dimensional information to the three-dimensional information update unit 13. For example, in the front stereo vision region V₁ in FIG. 2, three-dimensional information is generated for each unit region using a stereo matching technique for the same object (surrounding moving object, stationary object, road surface, and the like) captured in the image data P₂₁ of the front camera 21, the image data P₂₂ of the front right camera 22, and the image data P₂₆ of the front left camera 26.

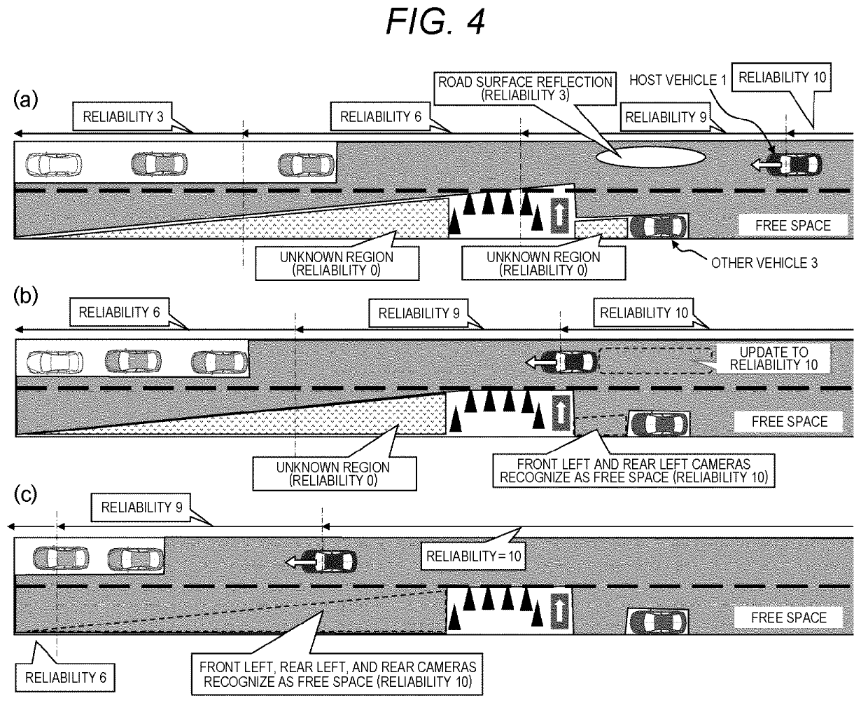

Note that the three-dimensional information generation unit 12 imparts reliability indicating a level of reliability of information to the generated three-dimensional information. For example, as illustrated in FIG. 4(a), reliability “0” indicating that the three-dimensional information is unknown is assigned to the three-dimensional information of the unit region that cannot be imaged because of being hidden by the other vehicle 3 that is stopped or a pylon. Furthermore, for example, any of the reliabilities “10” to “3” is assigned to the three-dimensional information of the unit region that can be clearly imaged so as to be substantially inversely proportional to the distance from the host vehicle 1. Further, for example, reliability “3” indicating that the reliability is not so high is given to the three-dimensional information of the unit region in which the noise such as the light reflected by the puddle is imaged.

In step S3, the three-dimensional information update unit 13 compares the current reliability of each unit region received from the three-dimensional information generation unit 12 with the past reliability of each unit region read from the three-dimensional information accumulation unit 14, and determines whether update is necessary. Then, if the update is necessary, the process proceeds to step S4, and if the update is unnecessary, the process proceeds to step S5.

In step S4, the three-dimensional information update unit 13 transmits the three-dimensional information of the unit region having higher current reliability than the past to the three-dimensional information accumulation unit 14. The three-dimensional information accumulation unit 14 updates the accumulated three-dimensional information using the three-dimensional information received from the three-dimensional information update unit 13.

For example, as illustrated in FIGS. 4(b) and 4(c), if the host vehicle 1 is moving forward, the reliability of the forward unit region is sequentially improved, and thus the three-dimensional information is sequentially updated for the forward unit region. On the other hand, since the reliability of the rear unit region sequentially deteriorates, the three-dimensional information of the rear unit region is not updated, and the three-dimensional information generated closest to the unit region is accumulated as it is.

In addition, for example, as illustrated in FIGS. 4(b) and 4(c), when the host vehicle 1 passes by the side of the unknown region, imaging of the unknown region becomes possible, and thus the three-dimensional information is sequentially updated also for the initial unknown region.

Note that, in a case where three-dimensional information based on different stereo vision regions V is generated for the same unit region, the three-dimensional information update unit 13 may transmit three-dimensional information with the highest reliability to the three-dimensional information accumulation unit 14. As a result, even in a case where backlight or lens contamination is imaged in the image data of any of the cameras 20, the image data can be stored by the image data of another camera 20.

In step S5, the three-dimensional information accumulation unit 14 accumulates the three-dimensional data having the highest reliability among the time-series three-dimensional data received from the three-dimensional information update unit 13 for each unit region. Note that the three-dimensional information for each unit region accumulated in the three-dimensional information accumulation unit 14 can be discarded in a case where a predetermined time has elapsed from the last update timing or a case where a predetermined distance or more has elapsed from the unit region.

In step S6, the road surface information estimation unit 15 identifies a road surface region around the host vehicle 1 from the three-dimensional information accumulated in the three-dimensional information accumulation unit 14, and estimates road surface information such as a relative road surface inclination with respect to the host vehicle reference surface and a height from the host vehicle reference point to the road surface.

In step S6, the free space recognition unit 16 recognizes a region where the host vehicle 1 can travel as a free space (shaded portion in FIG. 4) from the three-dimensional information accumulated in the three-dimensional information accumulation unit 14. The free space is a region where it is determined that the host vehicle 1 can travel safely without obstacles such as a median strip, a curbstone, a guardrail, a sidewalk, a construction site, and a pylon.

### <<Flowchart of Vehicle Action Plan Generation Processing>>

Next, processing for generating an action plan of the host vehicle 1, which is constantly performed in parallel with the processing of FIG. 4 during autonomous driving of the host vehicle 1, will be described with reference to a flowchart of FIG. 5.

In step S11, the sensor interface 11 receives the image data P (P₂₁ to P₂₆) from the camera 20 (21 to 26) and the audio data A from the microphone 30, and transmits the image data P and the audio data A to the specific vehicle recognition unit 17 and the specific vehicle information estimation unit 18, respectively.

In step S12, the specific vehicle recognition unit 17 detects other vehicles around the host vehicle 1 using a known image processing technology such as pattern recognition for each of the received image data P (P₂₁ to P₂₆), and individually tracks the detected other vehicles by attaching unique identification codes to the other vehicles. Note that, in this step, various types of information regarding other vehicles (for example, relative position information, relative speed information, dimension (width and height) information, distance information from the host vehicle, and the like of other vehicles) are also generated using a known image processing technology.

In step S13, the specific vehicle recognition unit 17 recognizes the specific vehicle 2 from the other vehicles detected in step S12 based on the received image data P (P₂₁ to P₂₆) or the audio data A. For example, if the specific vehicle 2 is a police vehicle, a fire engine, or the like, the specific vehicle 2 in emergency travel can be recognized based on the presence or absence of blinking of a rotating light (red light) and the presence or absence of a siren sound.

Note that the specific vehicle 2 in the present embodiment is not limited to the above-described emergency vehicle such as a police vehicle or a fire vehicle, and may include a route bus or a tailgating vehicle. In a case where the route bus is recognized as the specific vehicle 2, whether the host vehicle 1 is traveling on the bus priority road or whether the other vehicle detected in step S12 matches the bus pattern may be referred to. In addition, in a case where the tailgating vehicle is recognized as the specific vehicle 2, whether the vehicle is traveling for a predetermined time or more in a state where the inter-vehicle distance from the host vehicle 1 is equal to or less than a predetermined distance may be used as the determination criterion.

In step S14, it is determined whether the specific vehicle 2 is recognized in step S13. Then, in a case where it is recognized, the process proceeds to step S15, and in a case where it is not recognized, the process returns, and the process from step S11 is continued.

In step S15, the specific vehicle information estimation unit 18 acquires the road surface information estimated in step S6 of FIG. 3.

In step S16, the specific vehicle information estimation unit 18 corrects or estimates each information of the distance to the specific vehicle 2, the relative speed of the specific vehicle 2, and the dimensions (entire width, entire height, entire length) of the specific vehicle 2 using the acquired road surface information.

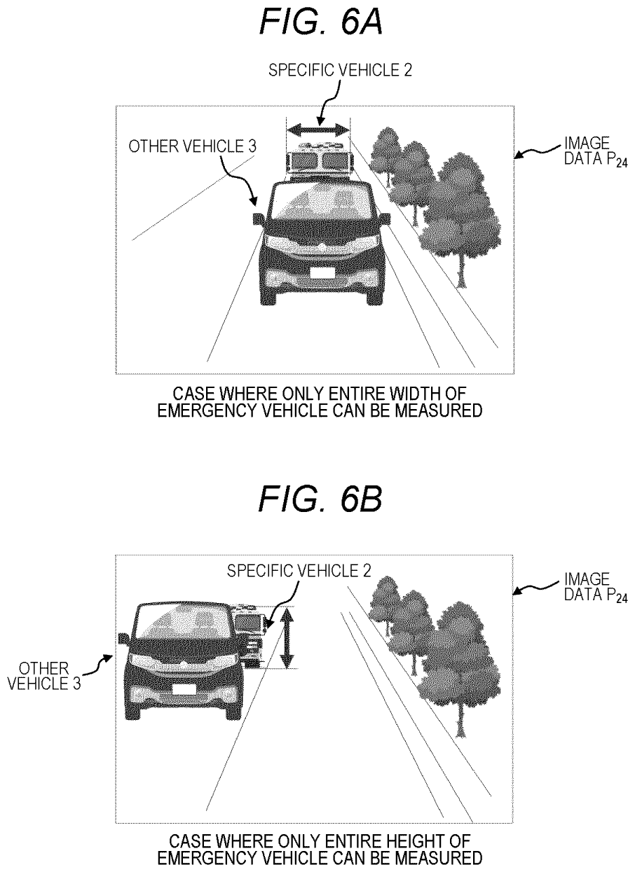

Here, since the entire length of the specific vehicle 2 is approximately proportional to the entire width and the entire height of the specific vehicle 2, even when the specific vehicle 2 in the image data P₂₄ captured by the rear camera 24 can measure only the entire width as illustrated in FIG. 6A, or even when the specific vehicle 2 in the image data P₂₄ can measure only the entire width as illustrated in FIG. 6B, the entire length of the specific vehicle 2 can be estimated based on the measured entire width or entire height.

In step S17, the specific vehicle passable region determination unit 19 acquires the free space information recognized in step S7 of FIG. 3.

In step S18, the specific vehicle passable region determination unit 19 determines a passable region having a size that allows the specific vehicle 2 to safely pass, in consideration of the dimensional information (entire width, entire length) and the free space information of the specific vehicle 2.

In step S19, the evacuation region determination unit la determines an evacuation region for the host vehicle 1 to evacuate so as not to disturb the passage of the specific vehicle 2 in consideration of the passable region and the free space information determined in step S18. In this step, a plurality of evacuation regions may be set.

In step S20, the vehicle action plan generation unit 1b generates an action plan of the host vehicle 1 on the basis of the passable region determined in step S18, the evacuation region determined in step S19, and the traffic rules registered in the traffic rule database 1c. Thus, the vehicle control device 40 can autonomously move the host vehicle 1 to the evacuation region by controlling the steering system, the driving system, and the braking system according to the generated action plan.

Note that the traffic rules registered in the traffic rule database 1c are, for example, as follows.
(1) In a case where the evacuation region is set in an intersection or a place with poor visibility, the vehicle avoids the evacuation region and is evacuated to another evacuation region.
(2) If the emergency vehicle 2 is sufficiently distant, the evacuation control is not performed.
(3) If the emergency vehicle 2 is an oncoming vehicle and there is a median strip, the evacuation control is not performed.
(4) The evacuation control is canceled when the emergency vehicle 2 overtakes the host vehicle 1.
(5) The evacuation control is stopped when the emergency vehicle 2 stops or turns right or left before overtaking the host vehicle 1.

Hereinafter, a specific example of the evacuation control by the host vehicle 1 of the present embodiment in which the processing of FIGS. 3 and 5 is constantly executed will be described.

### <First Evacuation Control Example>

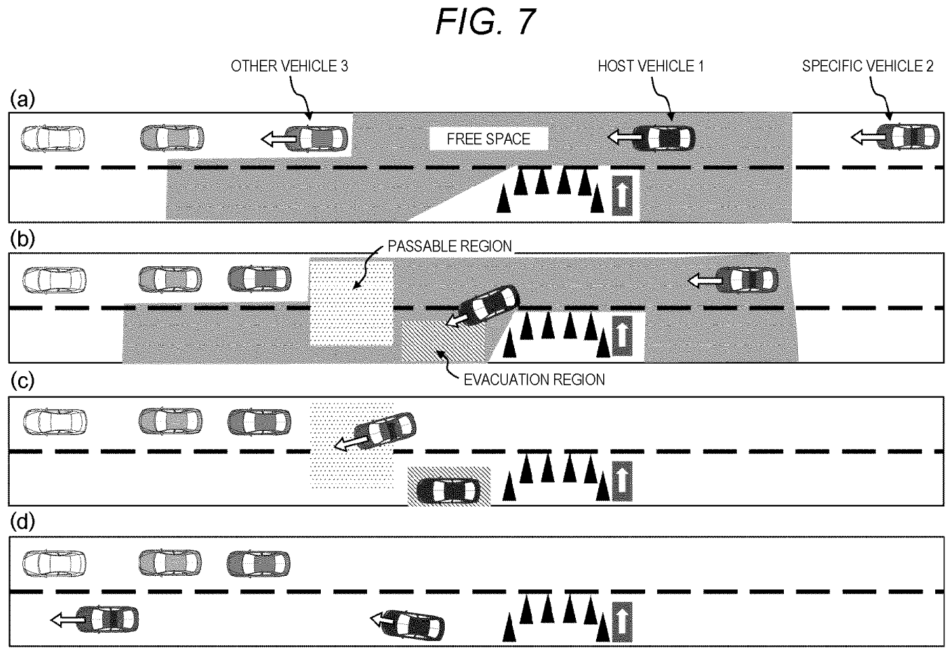

FIG. 7 illustrates an example of the evacuation control of the host vehicle 1 in a case where the specific vehicle 2 (police vehicle) approaches from behind the host vehicle 1 in a situation similar to that in FIG. 4.

At the time of FIG. 7(a), a free space having a shape indicated by hatching is recognized, and the approaching of the specific vehicle 2 is recognized. At this point, the passable region and the evacuation region are not set yet.

At the time of FIG. 7(b), a passable region having a size that allows the specific vehicle 2 to pass is set behind the other vehicle 3, and an evacuation region is set at a position that does not prevent the specific vehicle 2 from passing. Thereafter, the host vehicle 1 autonomously moves toward the evacuation region.

At the time point of FIG. 7(c), the host vehicle 1 stops in the evacuation region and waits for passage of the specific vehicle 2.

At the time of FIG. 7(d), since the passage of the specific vehicle 2 is confirmed, the host vehicle 1 stops the evacuation control, and autonomously returns to the normal automatic traveling control.

### <Second Evacuation Control Example>

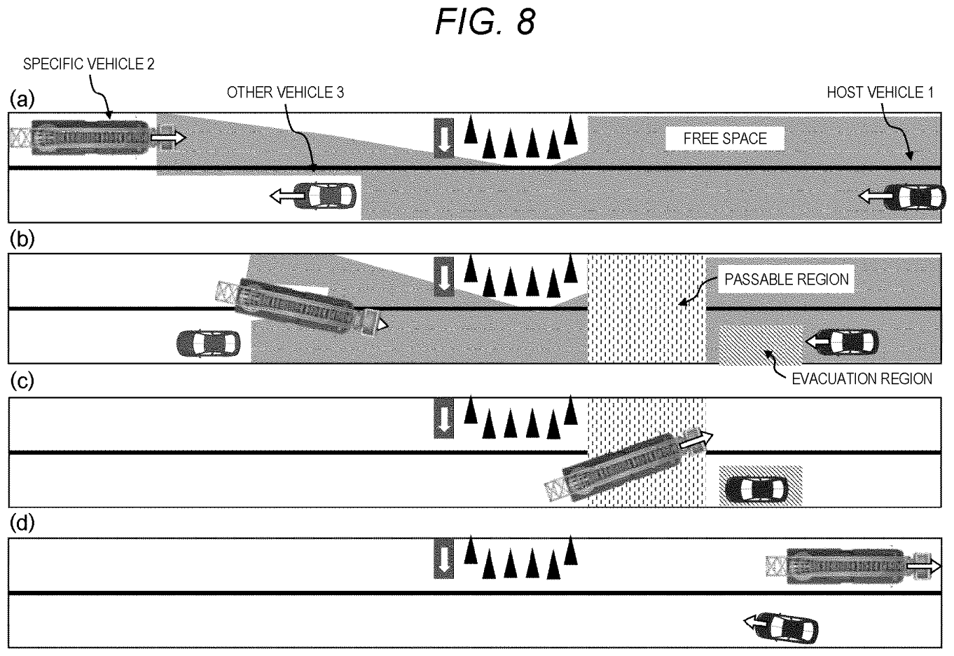

FIG. 8 illustrates an example of evacuation control of the host vehicle 1 in a case where the specific vehicle 2 (fire vehicle) approaches from the front of the host vehicle 1.

At the time of FIG. 8(a), a free space having a shape indicated by hatching is recognized, and the approaching of the specific vehicle 2 is recognized. At this point, the passable region and the evacuation region are not set yet.

At the time of FIG. 8(b), a passable region having a size that allows the specific vehicle 2 to pass is set in front of the pylon group, and an evacuation region is set at a position that does not prevent the specific vehicle 2 from passing. Thereafter, the host vehicle 1 autonomously moves toward the evacuation region.

At the time point of FIG. 8(c), the host vehicle 1 stops in the evacuation region and waits for passage of the specific vehicle 2.

At the time of FIG. 8(d), since the passage of the specific vehicle 2 is confirmed, the host vehicle 1 stops the evacuation control, and autonomously returns to the normal automatic traveling control.

### <Third Evacuation Control Example>

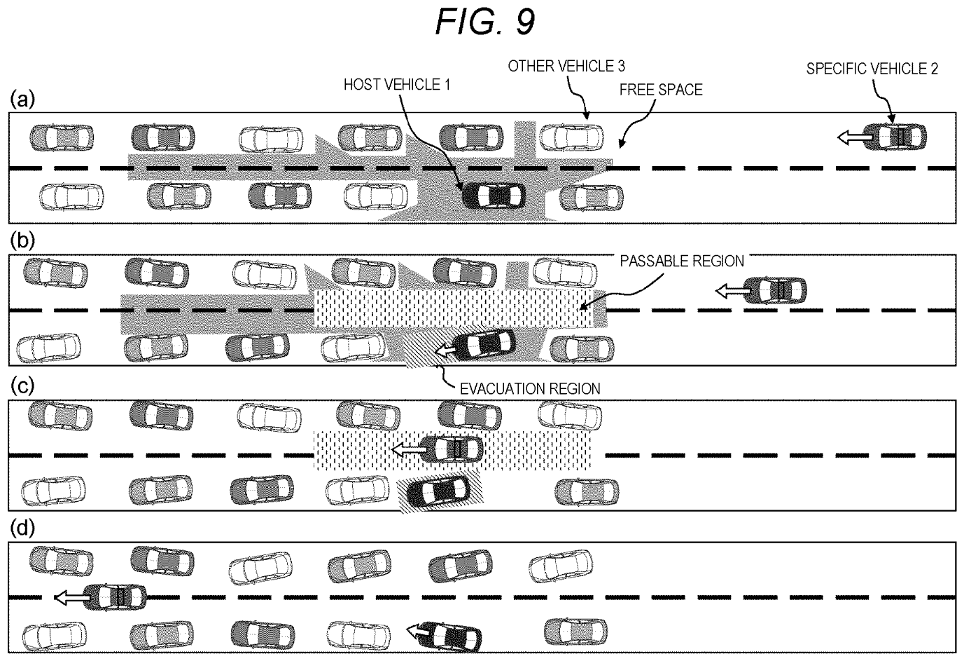

FIG. 9 illustrates an example of evacuation control of the host vehicle 1 in a case where the surrounding of the host vehicle 1 is congested and the specific vehicle 2 (police vehicle) approaches from behind the host vehicle 1.

At the time of FIG. 9(a), a free space having a shape indicated by hatching is recognized, and the approaching of the specific vehicle 2 is recognized. At this point, the passable region and the evacuation region are not set yet.

At the time point of FIG. 9(b), a passable region having a size that allows specific vehicle 2 to pass is set between the right lane and the left lane, and an evacuation region is set at a position that does not hinder the specific vehicle 2 from passing. Thereafter, the host vehicle 1 autonomously moves toward the evacuation region.

At the time point of FIG. 9(c), the host vehicle 1 stops in the evacuation region and waits for passage of the specific vehicle 2.

At the time of FIG. 9(d), since the passage of the specific vehicle 2 is confirmed, the host vehicle 1 stops the evacuation control and autonomously returns to the normal automatic traveling control.

### <Fourth Evacuation Control Example>

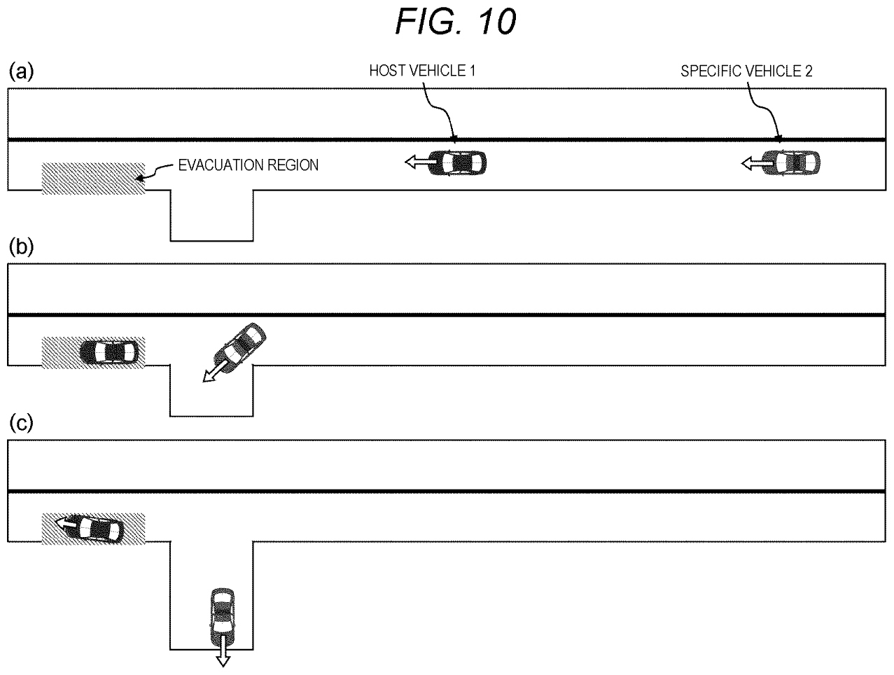

FIG. 10 illustrates an example of evacuation control of the host vehicle 1 in a case where the host vehicle 1 is heading for an intersection and the specific vehicle 2 (police vehicle) approaches from behind the host vehicle 1.

At the time point of FIG. 10(a), an evacuation region is set on the other side of the intersection. Note that the reason why the evacuation region is set on the other side of the intersection is to set the evacuation region at a position where the specific vehicle 2 does not obstruct the passage of the specific vehicle 2 regardless of which course the specific vehicle 2 takes because it is unclear whether the specific vehicle 2 goes straight or turns left at this time.

At the time point of FIG. 10(b), the host vehicle 1 is stopped in the evacuation region, and the specific vehicle 2 turns left at the intersection.

At the time point of FIG. 10(c), since the detection of the specific vehicle 2 is released, the host vehicle 1 stops the evacuation control, and autonomously returns to the normal automatic traveling control.

### <Fifth Example Evacuation Control>

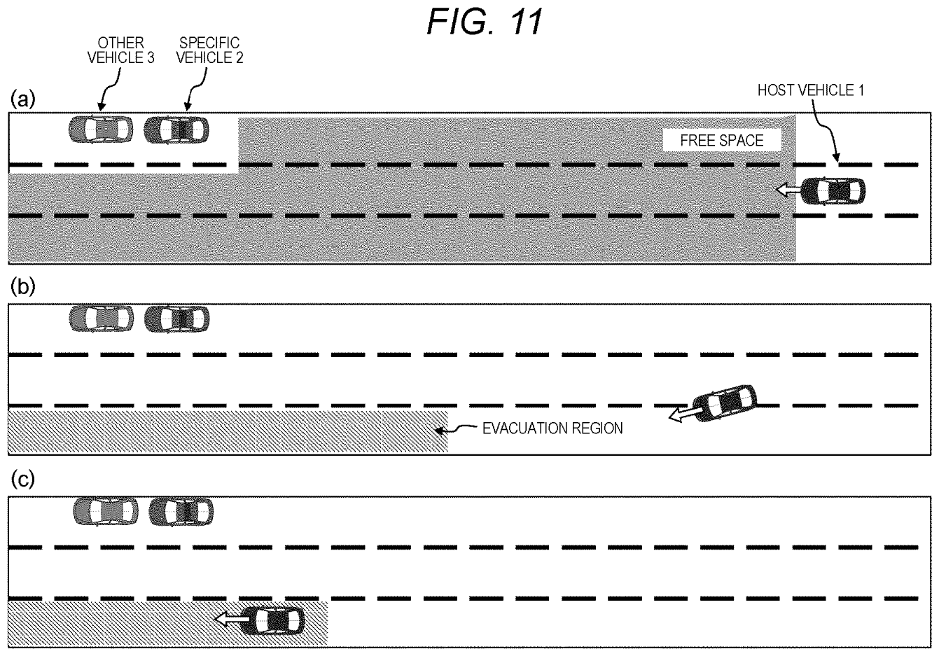

FIG. 11 illustrates an example of evacuation control of the host vehicle 1 in a case where the host vehicle 1 is traveling in the center lane on a three-lane straight road in the United States and the specific vehicle 2 (police vehicle) and the other vehicle 3 are stopped in the right lane. Note that, in the United States, there is a traffic rule that, when a police vehicle is stopped, traveling in an adjacent lane is prohibited, and when the stop lane of the police vehicle and the adjacent lane are avoided, the host vehicle 1 is allowed to continue traveling at a slow speed. Therefore, the above-described traffic rule is registered in the traffic rule database 1c of the present example, and it is assumed that the evacuation region conforming to the traffic rules can be set.

At the time point of FIG. 11(a), a free space having a shape indicated by hatching is recognized, and the specific vehicle 2 that is stopped is recognized. Note that, at this time point, the evacuation region has not yet been set.

At the time point of FIG. 11(b), the evacuation region is set to the left lane avoiding the stop lane (right lane) of the police vehicle and its adjacent lane (center lane) in accordance with the traffic rules described above. Thereafter, the host vehicle 1 autonomously moves toward the evacuation region.

At the time point of FIG. 11(c), the host vehicle 1 travels slowly in the evacuation region and overtakes the specific vehicle 2. Although not illustrated, after passing the specific vehicle 2, the host vehicle 1 stops the evacuation control and autonomously returns to normal automatic traveling control.

According to the external environment recognition device of the present embodiment described above, even in a vehicle not equipped with a distance sensor such as a radar, a LiDAR, an ultrasonic sensor, or an infrared sensor, it is possible to determine a place where the host vehicle can safely retreat when the specific vehicle approaches by using a plurality of cameras in combination.

### Second Embodiment

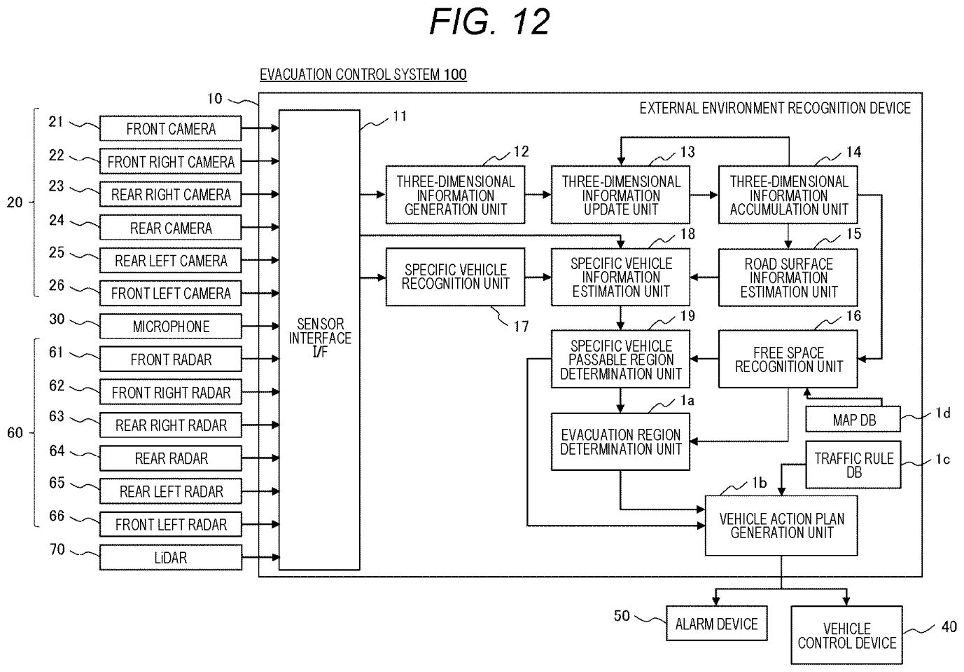

Next, an external environment recognition device 10 according to a second embodiment of the present invention will be described with reference to FIG. 12. Redundant description of common points with the first embodiment will be omitted.

The host vehicle 1 of the first embodiment is not equipped with a distance sensor such as a radar, a LiDAR, an ultrasonic sensor, or an infrared sensor, but the host vehicle 1 of the present embodiment is equipped with a radar 60 (61 to 66) and a LIDAR 70 as distance sensors. In addition, the external environment recognition device 10 of the present embodiment includes a map database 1d in addition to the configuration described in the first embodiment.

The three-dimensional information generation unit 12, the specific vehicle recognition unit 17, and the specific vehicle information estimation unit 18 basically have functions equivalent to those of the first embodiment, but in the present embodiment, by using the outputs of the radar 60 (61 to 66) and the LiDAR 70, it is possible to generate three-dimensional information or recognize a specific vehicle with higher accuracy.

In addition, since the information for each lane regarding the road on which the host vehicle 1 is traveling is registered in the map database, when the passable region or the evacuation region is determined, the passable region or the evacuation region can be determined in consideration of the circumstances peculiar to the lane, such as the width of the traveling road being narrowed, the region in the tunnel or on the bridge and having a sufficient size cannot be secured, or the bus priority road.

### REFERENCE SIGNS LIST

1 host vehicle
2 specific vehicle
3 other vehicle
100 evacuation control system
10 external environment recognition device
11 sensor interface
12 three-dimensional information generation unit
13 three-dimensional information update unit
14 three-dimensional information accumulation unit
15 road surface information estimation unit
16 free space recognition unit
17 specific vehicle recognition unit
18 specific vehicle information estimation unit
19 specific vehicle passable region determination unit
1a evacuation region determination unit
1b vehicle action plan generation unit
1c traffic rule database
1d map database
20 (21 to 26) camera
30 microphone
40 vehicle control device
50 alarm device
60 (61 to 66) radar
70 LiDAR
C visual field region
V stereo vision region
P image data
A audio data

1. An external environment recognition device comprising:
a plurality of cameras installed in such a way to have a plurality of stereo vision regions in which at least a part of a visual field region overlaps around a host vehicle;
a three-dimensional information generation unit that generates three-dimensional information by performing stereo matching processing in each of the plurality of stereo vision regions;
a three-dimensional information accumulation unit that accumulates the three-dimensional information generated during traveling of the host vehicle in time series; and
a three-dimensional information update unit that updates the three-dimensional information accumulated in the three-dimensional information accumulation unit using three-dimensional information newly generated by the three-dimensional information generation unit.

2. The external environment recognition device according to claim 1, further comprising:
a specific vehicle recognition unit that recognizes a specific vehicle to be controlled among other vehicles around a host vehicle using an image acquired by at least one of the cameras;
a road surface information estimation unit that estimates a road surface shape based on the three-dimensional information accumulated in the three-dimensional information accumulation unit;
a specific vehicle information estimation unit that estimates a position and a size of the specific vehicle based on an image acquired by the camera and a road surface shape estimated by the road surface information estimation unit;
a free space recognition unit that recognizes a free space in which a vehicle is allowed to travel based on the three-dimensional information accumulated in the three-dimensional information accumulation unit;
a specific vehicle passable region determination unit that determines a specific vehicle passable region through which the specific vehicle is allowed to pass in the free space based on a position and a size of the specific vehicle estimated by the specific vehicle information estimation unit;
an evacuation region determination unit that determines an evacuation region in which the host vehicle evacuates based on the specific vehicle passable region and the free space; and
a vehicle action plan generation unit that generates an action plan of the host vehicle based on the evacuation region.

3. The external environment recognition device according to claim 2, further comprising a traffic rule database in which traffic rules are registered,
wherein the vehicle action plan generation unit generates the action plan in accordance with the traffic rules.

4. The external environment recognition device according to claim 2, further comprising a map database in which road information is registered,
wherein the vehicle action plan generation unit generates the action plan in accordance with the road information.

5. The external environment recognition device according to claim 2, wherein the specific vehicle recognition unit recognizes a specific vehicle in emergency travel based on presence or absence of blinking of a rotating light in the image.

6. The external environment recognition device according to claim 2, wherein the specific vehicle recognition unit recognizes a bus traveling on a bus priority road as the specific vehicle.

7. An external environment recognition method for recognizing an external environment based on images captured by a plurality of cameras installed in such a way to have a plurality of stereo vision regions in which at least a part of a visual field region overlaps around a host vehicle, the external environment recognition method comprising:
a three-dimensional: information generation step of generating three-dimensional information by performing stereo matching processing in each of the plurality of stereo vision regions;
a three-dimensional information accumulation step of accumulating the three-dimensional information generated during traveling of the host vehicle in time series; and
a three-dimensional information update step of updating the accumulated three-dimensional information using newly generated three-dimensional information.
